(19) United States
(12) Patent Application Publication
(10) Pub. No.: US 2004/0092352 A1
(43) Pub. Date: May 13, 2004

(54) Bicycle chain wheel assembly

(76) Inventor: Cheng-Hsun Chiang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/291,435

(22) Filed: Nov. 12, 2002

(51) Int. Cl. F16H 55/30; F16H 55/12

(52) U.S. Cl. 474/160; 474/152

(57) ABSTRACT

A bicycle chain wheel assembly includes an outer ring made of Aluminum Alloy with teeth defined in an outer periphery thereof, and an inner ring made of composite material which is light in weight. The inner ring is securely connected to an inner periphery of the outer ring by rivets. The chain wheel has durable outer ring that is engaged with bicycle chain and light inner ring, so that the whole weight of the chain wheel is light and meets the requirement of a modern bicycle.

### FIELD OF THE INVENTION

The present invention relates to a bicycle chain assembly which includes a outer ring with teeth and made of Aluminum Alloy, and an inner ring made of composite material which is connected to an inner periphery of the outer ring.

### BACKGROUND OF THE INVENTION

A conventional chain wheel for bicycles is a thin disk and made of metal which is durable for friction so that the teeth of the chain wheel may be used for a long period of time with the chain. The metal made chain wheel is heavy which is the last factor that a modern bicycle wants. The weight for a modern bicycle is required to be less than 10 Kgs. so that the conventional chain wheel made of metal cannot meet the requirement.

The present invention intends to provide a chain wheel for bicycles and is composed of an outer ring made of Aluminum Alloy and an inner ring made of composite material. The chain wheel is light in weight and has durable feature.

### SUMMARY OF THE INVENTION

In accordance with one aspect of the present invention, there is provided a bicycle chain wheel assembly which comprises an outer ring made of Aluminum Alloy and having teeth defined in an outer periphery of the outer ring. An inner ring made of composite material is connected to an inner periphery of the outer ring.

The primary object of the present invention is to provide a light and durable chain wheel for bicycles.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the chain wheel of the present invention;

FIG. 2 is an exploded view to show the outer ring and the inner ring of the chain wheel of the present invention; and

FIG. 3 shows a gap is defined between the outer ring and the inner ring of the chain wheel of the present invention.

### DETAILED DESCRIPTION OF THE PREFERRED EMBODIMENT

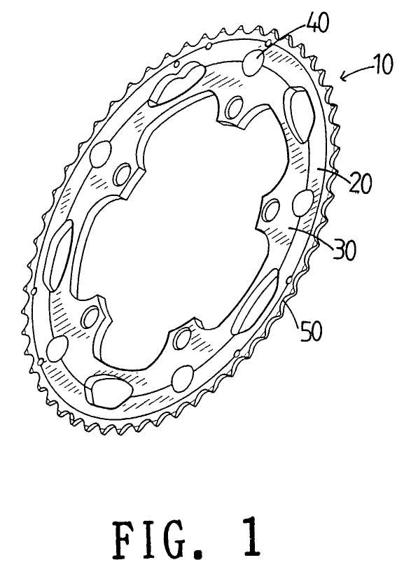

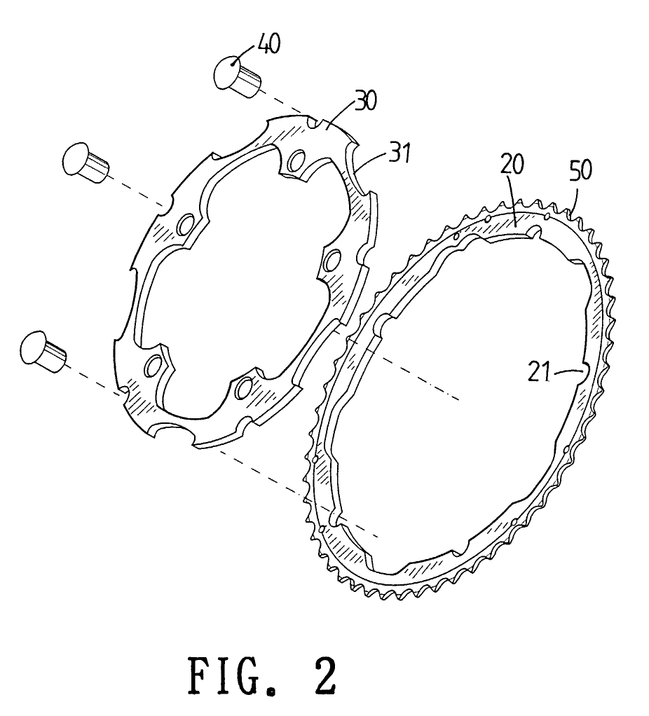

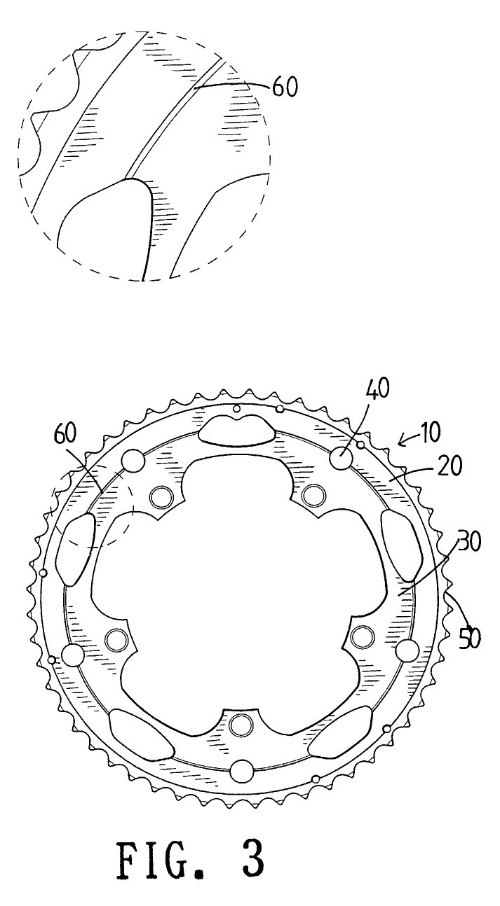

Referring to FIGS. 1 to 3, the chain wheel 10 for bicycles of the present invention comprises an outer ring 20 made of Aluminum Alloy and having teeth 50 defined in an outer periphery of the outer ring 20. A plurality of first notches 21 are defined in an inner periphery of the outer ring 20.

An inner ring 30 is made of composite material such as carbon fiber and has a plurality of second notches 31 defined in an outer periphery thereof. The inner ring 30 is engaged with the inner periphery of the outer ring 20 with the first notches 21 cooperated with the second notches 31. A plurality of rivets 40 extend through holes enclosed by the first notches 21 and the second notches 31 to connect the inner ring 30 with the outer ring 20.

A gap 60 is defined between the inner periphery of the outer ring 20 and an outer periphery of the inner ring 30 so that the gap 60 is expected to absorb the deformation of the inner ring 30 and/or the outer ring 20.

The shape of the inner ring 30 and/or the outer ring 20 can be designed to be the desired shapes so as to increase the commercial value. Either of the inner ring 30 or the outer ring 20 can be replaced individually so as to reduce the cost of maintenance.

While we have shown and described the embodiment in accordance with the present invention, it should be clear to those skilled in the art that further embodiments may be made without departing from the scope of the present invention.

What is claimed is:

1. A bicycle chain wheel assembly comprising:
an outer ring made of Aluminum Alloy and having teeth defined in an outer periphery of the outer ring, and
an inner ring made of composite material and connected to an inner periphery of the outer ring.

2. The bicycle chain wheel assembly as claimed in claim 1 further comprising a gap defined between the inner periphery of the outer ring and an outer periphery of the inner ring.

3. The bicycle chain wheel assembly as claimed in claim 1, wherein a plurality of first notches are defined in the inner periphery of the outer ring and the inner ring has a plurality of second notches defined in an outer periphery thereof, the first notches cooperated with the second notches to form a plurality of holes, a plurality of rivets extending through holes enclosed by the first notches and the second notches so as to connect the inner ring with the outer ring.
